(19) United States
(12) Patent Application Publication
(10) Pub. No.: US 2024/0172049 A1
(43) Pub. Date: May 23, 2024

(54) METHODS AND APPARATUS FOR DATA TRANSMISSION TRAFFIC INFORMATION INDICATION FOR EXTENDED REALITY (XR) DEVICES

(71) Applicant: Apple Inc., Cupertino, CA (US)

(72) Inventors: Weidong Yang; Chunhai Yao, Beijing (CN); Chunxuan Ye, San Diego, CA (US); Dawei Zhang, Saratoga, CA (US); Haitong Sun, Cupertino, CA (US); Hong He, San Jose, CA (US); Huaning Niu, San Jose, CA (US); Oghenekome Oteri, San Diego, CA (US); Seyed Ali Akbar Fakoorian, San Diego, CA (US); Sigen Ye, San Diego, CA (US); Wei Zeng, Saratoga, CA (US); Yushu Zhang, Beijing (CN)

(21) Appl. No.: 17/778,035

(22) PCT Filed: Sep. 3, 2021
(86) PCT No.: PCT/CN2021/116563

§ 371 Date: Mar. 9, 2023

(51) Int. Cl. H04W 28/18; H04B 7/06; H04W 72/11; H04W 72/21; H04W 76/20

(52) U.S. Cl. CPC H04W 28/18; H04B 7/0626; H04W 72/11; H04W 72/21; H04W 76/20

(57) ABSTRACT

A method is to provide traffic related information in lower layers for an XR system and associated apparatuses. In one aspect, a user equipment (UE) is configured to receive traffic related information from a peer UE or an application server. The UE then transmits the traffic related information to a base station (BS) using a radio resource control (RRC) message such as UEAssistanceInformation as provided by 3GPP technical specifications, a medium access control (MAC) control element (CE), or a physical uplink control channel (PUCCH). The transmission of the traffic related information from the UE enhances the wireless communication service for the XR system.

### FIELD

This invention relates to wireless data transmission technology and to traffic information indication for extended reality (XR) devices

### BACKGROUND

Mobile communication in the next-generation wireless communication system, 5G, or new radio (NR) network will provide ubiquitous connectivity and access to information, as well as the ability to share data around the globe. 5G networks and network slicing will be a unified, service-based framework that will target to meet versatile and sometimes conflicting performance criteria and provide services to vastly heterogeneous application domains, including extended reality (XR) applications such as augmented reality (AR) or virtual reality (VR) applications.

For XR applications such as cloud gaming, tremendous data exchange such as audio and video streaming is needed between user equipment (UEs) and radio access network (RAN), and low latency and fast speed are demanded. Quality of service (QoS) is one measurement of the overall performance of a service experienced by a user of the network, and QoS flows provide priority information to different applications, users, or data communications.

### BRIEF DESCRIPTION OF THE DRAWINGS

FIG. 1 illustrates a block diagram illustrating an architecture of a wireless system including a user equipment (UE) transmitting traffic related information to a base station (BS) in accordance with some aspects.

FIG. 2 illustrates a flow diagram showing a method of transmitting traffic related information by a UE to a BS using an RRC message in accordance with some aspects.

FIG. 3 illustrates a diagram showing an example definition of traffic information included in the RRC message of FIG. 2 in accordance with some aspects.

FIG. 4 illustrates a diagram showing an example definition of traffic information included in the RRC message of FIG. 2 in accordance with some additional aspects.

FIG. 5 illustrates a flow diagram showing a method of traffic information indication for downlink data transmission of an extended reality (XR) device in accordance with some aspects.

FIG. 6 illustrates a flow diagram showing a method of traffic information indication for uplink data transmission of an extended reality (XR) device in accordance with some aspects.

FIG. 7 illustrates a diagram illustrating example components of a device that can be employed in accordance with some aspects.

FIG. 8 illustrates a diagram illustrating example interfaces of baseband circuitry that can be employed in accordance with some aspects.

FIG. 9 illustrates a diagram illustrating an example IPv6 header in accordance with some aspects.

FIG. 10 illustrates a diagram illustrating an example flow label including of a number of sub-fields in accordance with some aspects.

### DETAILED DESCRIPTION

The present disclosure is described with reference to the attached figures. The like reference numerals are used to refer to like elements throughout. The figures are not drawn to scale, and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

A user plane function (UPF) in the core network marks incoming internet protocol (IP) packets (or ethernet packets) and provides QoS flow identity (QFI) labels for the IP packets through an N3 interface between the UPF and gNB. In the considered QoS enhancements, differentiated treatment of I-frames and P-frames of a video stream may be desirable, which creates a need to support finer QoS granularities below a QoS flow. In other cases, out of a single video frame (e.g. an I-frame or a P-frame), multiple IP packets are generated. Depending on the way media payload is partitioned, in one setup or implementation, one or more IP packet may be of use to the application on the UE side even though not all the IP packets from the video frame are received correctly. In another setup or implementation, if any IP packet for a video frame is not received correctly, then the application on the UE side cannot use any of the remaining IP packets. Hence, a sensible treatment would be to drop all the IP packets for that video frame. From that, it is understood a bundle of IP packets needs to be received correctly together to be of use to the application at UE in some cases. Hence if a bundle of IP packets should be labelled or marked in a way, the radio network can take necessary treatment considering their input/use to the application as a whole. For a video frame, a delayed frame may be of little value depending on the video decoder setup/operational mode. Therefore, all IP packets for a video frame may be dropped if one IP packet (e.g. the last IP packet) for a video frame cannot be received correctly within a delay bound. Multiple data flows are presented in some XR applications. For example, audio stream, video stream (even multiple video streams), and data stream may be present in some AR applications. For such applications, timely delivery of the data packets from multiple data flows is important. For example, the packets from the audio stream and the video stream for an XR application should be delivered synchronously, so the application can utilize them together. Accordingly, marking or labeling of the packets across data flows (bundles across data flows), and a linkage among bundles across the data flows are needed. When encryption is not used at various layers, a network node such as the UPF or gNB may be able to obtain detailed information about a packet. In that case, if XR application marks packets in specific ways, and those markings are understood by the 5G network including the UPF and/or gNB, then the needed enhancements to support finer QoS granularity (e.g. to differentiate I-frames and P-frames in a video stream), and bundling marking for packets within the same media/data flow or across media/data flows can be supported. In one case, the N3 interface can be enhanced to provide enhanced QoS support for XR by providing marking of IP packet with 5-tuple {dest addr, source addr, protocol, dest port, source port} and higher layer header information.

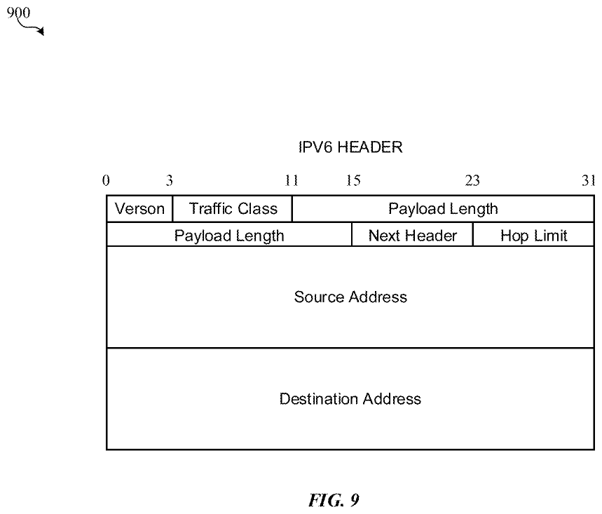

In another case, still assuming traffic related information is visible at gNB, gNB can obtain finer details about an IP packet by checking headers at various protocol layers, and differentiated treatment at the radio access network of packets in the same QoS flow is then possible, effectively creating sub-QoS flows under a single QoS flow. When encryption is used at some layer(s), for example in webRTC it is mandated secure real-time transport protocol (SRTP) for which the payload is encrypted is used. As a result, much of the header fields in the application layer is not visible for inspection. In another example, when IPsec is used, depending on the operation mode, header information such as the original source address, destination address, source port, destination port, etc. may not be visible. FIG. 9 illustrates a diagram 900 showing an example IPv6 header. As shown in FIG. 9, in an IPV6 IP packet, its header may include fields such as “version”, “traffic class”, “flow label”, “payload length”, etc. In some cases, the IPsec protocol does not include a Flow Label of a IPv6 header in any of its cryptographic calculations. In some cases, with IPV6, the flow label may be left unchanged en route even with IPsec. If “Traffic Class” or any other fields in a IP packet is also left unchanged en route, then “traffic class” or any other fields can be used for marking/classification by UPF/gNB.

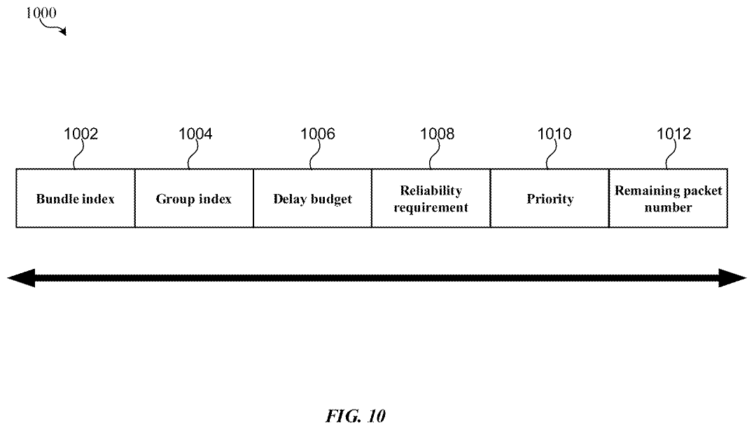

The discussion below focuses on the “flow label” part. The flow label along with source address and destination address may be used to mark IP packets from the same bundle in a data flow, e.g. those IP packets are given a same value (a first value) for the “flow label”. Then for the IP packets from another bundle in the data flow, IP packets are given a same value (a second value) for “flow label”, the second value is different from the first value. To mark IP packets from bundles of different data flows (effectively marking bundle of bundles), the same value can be used for “flow label” for IP packets in the bundle of bundles. As “flow label” consists of 20 bits, it is also possible to carry more information in “flow label”. FIG. 10 illustrates a diagram 1000 of an example flow label including a number of sub-fields in accordance with some aspects. As shown in FIG. 10, the flow label comprises of a number of sub-fields, such as a bundle index 1002, a group index 1004, a delay budget 1006, a reliability requirement 1008, a priority 1010, or a remaining packet number 1012. The bundle index 1002 can be populated by a random number generator to create a tag for a bundle or a bundle of bundles. The group index 1004 can be used to differentiate traffic flows within a bundle or within a bundle of bundles. For example, packets within the same traffic flows share the same value for “group index” but packets from different traffic flows have different values for “group index”. In one example, packets for the video stream have “1” for group index, and packets for the audio stream have “2” for group index. The delay budget 1006 may be for the current packet. For example, the delay budget 1006 may be with a reference to a clock or the UTC time. The reliability requirement 1008 may be for the current packet. For example, the reliability requirement 1008 may indicate a low reliability, e.g. targeting packet error rate at 1% or a high reliability targeting packet error rate at 0.1%. The priority 1010 is to define discarding behavior. For example, with 4 levels for priority, then when network cannot deliver all packets in a bundle or a bundle of bundles, it starts to discard all the packets of the lowest priority first. If it still cannot deliver all the rest packets in the bundle or the bundle of bundles, it discards all the packets in the next level of priority. The remaining packet number 1012 provides the visibility to UPF/gNB so the network node is aware how many packets remain for a traffic flow (marked with the group index 1004) to help it make scheduling/classification decision. In some embodiments, the “remaining packet number” field can be replaced with a “remaining packet size” field which can be used to indicate how many bytes remain in the current bundle after the current packet. In some embodiments, not all sub-fields are present. In some embodiments, to randomize the value in “flow label”, a pseudo-random permutation or a pseudo-random sequence mask can be applied to the raw bits in one or more sub-fields. In some embodiments, a pseudo-random mask can be generated as a segment of a pseudo-random sequence such as a Gold sequence with seed from a hash function with a time value and one or more tags. In some embodiments, the time value is the current UTC time with truncation. In some embodiments, the time value is the current UTC time with a time offset (e.g. 2 seconds), the time offset can be informed to the XR client at the UE through higher layer protocol, and the time offset can be provided to UPF/gNB by the UE. In some embodiments, one tag is associated with the XR client on the UE. In some embodiments, one tag is associated with the XR server or the peer UE. The XR server or the UE can inform UPF/gNB of one or more tag. UPF/gNB is able to regenerate the pseudo-random mask to retrieve the unmasked one or more sub-fields. The pseudo-random mask can be generated periodically, the periodicity can be chosen so large that any timing difference between XR server/the peer UE and UPF/gNB does not materially impact the synchronized generation of the pseudo-random sequence at both the XR server/the peer UE and UPF/gNB. With the disclosed sub-fields for the “flow label”, assume a single source IP address and a single destination address are used for all traffic flows, UPF/gNB can mark/classify the incoming IP packets. However, if multiple source IP addresses and/or multiple destination IP addresses are used for packets for an XR application, it may not be easy for the network node to be aware of the linkage among different flows.

In some aspect extended reality (XR) applications, quality of service (QoS) flows are established to transfer QoS parameters from an application server to a base station, which include traffic information that helps to determine a priority of bandwidth allocation. However, current QoS parameters may not reflect all desired traffic related information to enhance the radio access network communication for XR. For example, the encryption needs hinder the base station/UPF/session management function (SMF) from determining finer QoS requirements, such as QoS requirements for I-frames or P-frames of video frames. On the other hand, a QoS descriptor is associated with a value in the flow labels (e.g., a flow label for an I-frame or a flow label for a P-frame), and multiple QoS descriptors can be indicated with multiple flow labels. A UE has such information more readily available than the base station/UPF/SMF. For example, the client at the UE and its peer can negotiate a labeling scheme and thus can deduce or ascribe a meaning to a label. In some instances, the UE may better appreciate traffic information than the base station/UPF/SMF. For example, the UE can identify different distributions of the I-frames and the P-frames from packet sizes. If the UE passes along the difference information to the base station, the base station can use that information for differentiated scheduling treatment. If multiple source IP addresses and/or multiple destination IP addresses are used for packets for the same XR application, the UE can indicate to the gNB or SMF/UPF the linkage of {Source IP address-1, destination IP address-1} and {Source IP address-2, destination IP address-2}. If other information such as port number are available, the UE can include the information there, e.g. {Source IP address-1, destination IP address-1, source port-1, destination port-1} and {Source IP address-2, destination IP address-2, source port-2, destination port-2}.

Also, QoS parameters may not include specific uplink or downlink periodicity and offset. For example, multiple uplink configured grants with different periodicities and offsets may meet the QoS requirements, but power consumptions are different. In addition, since QoS is a high layer signaling, it may not well indicate characteristics of lower layers. For example, when a video codec cadence is reduced adapted to a deteriorated radio link, such a traffic variation may not be reflected in the QoS requirements, and thus power consumption and feedback signaling overhead may not be optimized.

In view of the above, the disclosure is related to a method to provide traffic related information by a UE in lower layers for an XR system and associated apparatuses in order to enhance the radio access network for XR. In one aspect, a user equipment (UE) is configured to receive traffic related information from a peer UE or an application server. The UE then transmits the traffic related information to a base station (BS). In some aspects, the traffic related information is transmitted through a radio resource control (RRC) message. An example of such an RRC message includes a UE assistance information message UEAssistanceInformation as provided by 3GPP technical specifications. In some further aspects, the traffic related information is transmitted through a medium access control (MAC) control element (CE). In some further aspects, the traffic related information is transmitted through a physical uplink control channel (PUCCH). The traffic related information may include downlink traffic information, uplink traffic information, and channel configuration preference information are further described below with reference to figures together with additional aspects and details of the disclosure.

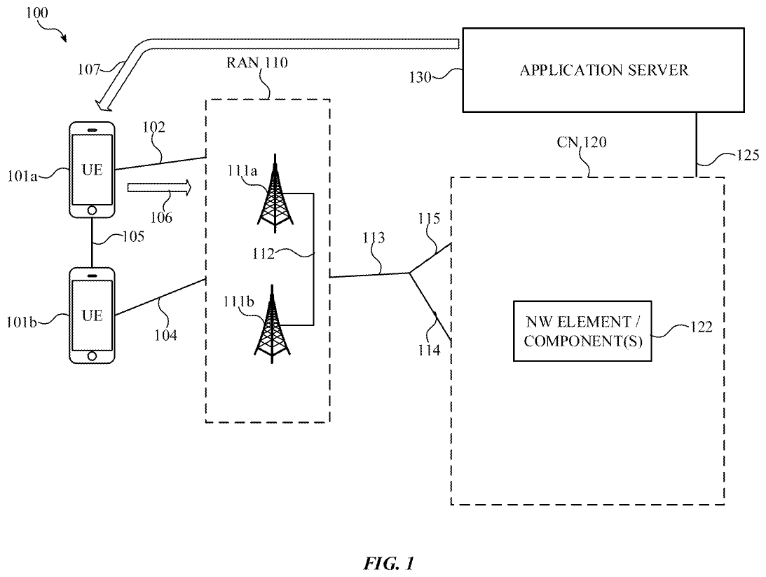

FIG. 1 illustrates a block diagram illustrating an architecture of a wireless system 100 including a UE transmitting traffic related information to a BS in accordance with some aspects. The following description is provided in conjunction with 5G or NR system standards as provided by 3GPP technical specifications. However, the example embodiments are not limited in this regard, and the described embodiments can apply to other networks that benefit from the principles described herein, such as future 3GPP systems (e.g., Sixth Generation (6G)) systems, IEEE 802.16 protocols (e.g., WMAN, WiMAX, etc.), or the like.

As shown by FIG. 1, the wireless system 100 includes UE 101a and UE 101b (collectively referred to as “UEs 101” or “UE 101”). In this example, UEs 101 are illustrated as smartphones (e.g., handheld touchscreen mobile computing devices connectable to one or more cellular networks), but can comprise any mobile or non-mobile computing device, such as consumer electronics devices including headset, handset, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, Machine Type Communication (MTC) devices, Machine to Machine (M2M), Internet of Things (IoT) devices, and/or the like.

The UEs 101 can be configured to connect, for example, communicatively couple, with a Radio Access Network (RAN) 110. In some aspects, the RAN 110 can be a next generation (NG) RAN or a 5G RAN, an evolved-UMTS Terrestrial RAN (E-UTRAN), or a legacy RAN, such as a UTRAN or GERAN. As used herein, the term “NG RAN” or the like can refer to a RAN 110 that operates in an NR or 5G wireless system 100, and the term “E-UTRAN” or the like can refer to a RAN 110 that operates in an LTE or 4G system 100. The UEs 101 utilize connections (or channels) 102 and 104, which respectively comprise a physical communications channel/interface. In this example, the connections 102 and 104 are illustrated as an air interface to enable communicative coupling and can be consistent with cellular communications protocols, such as a Global System for Mobile communications (GSM) protocol, a Code-Division Multiple Access (CDMA) network protocol, a Push-to-Talk (PTT) protocol, a PTT over-cellular (POC) protocol, a Universal Mobile Telecommunications Service (UMTS) protocol, a 3GPP LTE protocol, a 5G protocol, an NR protocol, and/or any of the other communications protocols discussed herein. In embodiments, the UEs 101 can directly exchange communication data via a ProSe interface 105. The ProSe interface 105 can alternatively be referred to as an SL interface 105 and can comprise one or more logical channels, including but not limited to a physical sidelink control channel (PSCCH), a physical sidelink shared channel (PSSCH), a physical sidelink discovery channel (PSDCH), and a physical sidelink broadcast channel (PSBCH).

The RAN 110 can include one or more RAN nodes including BS 111a and 111b (collectively referred to as “BS 111”), that enable the connections 102 and 104. As used herein, the terms “access node,” “access point,” or the like can describe equipment that provides the radio baseband functions for data and/or voice connectivity between a network and one or more users. These BS can be referred to as access nodes, gNBs, RAN nodes, eNBs, NodeBs, RSUs, Transmission Reception Points (TRxPs) or TRPs, and so forth, and can comprise ground stations (e.g., terrestrial access points) or satellite stations providing coverage within a geographic area (e.g., a cell). According to various embodiments, the BS 111 can be implemented as one or more of a dedicated physical device such as a macrocell base station and/or a low power (LP) base station for providing femtocells, picocells, or other like cells having smaller coverage areas, smaller user capacity, or higher bandwidth compared to macrocells.

The RAN 110 is communicatively coupled to a core network (CN) 120. The CN 120 can comprise a plurality of network elements 122 configured to offer various data and telecommunications services to customers/subscribers (e.g., users of UEs 101) who are connected to the CN 120 via the RAN 110.

An application server 130 can be an element offering applications that use IP bearer resources with the CN 120 via an Internet Protocol (IP) interface 125 (e.g., Universal Mobile Telecommunications System Packet Services (UMTS PS) domain, LTE PS data services, etc.). The application server 130 can also be configured to support one or more communication services (e.g., VoIP sessions, PTT sessions, group communication sessions, social networking services, etc.) for the UEs 101 via the CN 120. The application server 130 can signal the CN 120 to indicate a new service flow and select an appropriate QoS and charging parameters with the appropriate traffic flow template (TFT) and QoS class of identifier (QCI), which commences the QoS and charging as specified by the application server 130.

In some aspects, the UE 101 derives uplink traffic related information and collects downlink traffic related information from a peer UE or the application server 130 as indicated by arrow 107. For example, the downlink traffic related information may be collected through an application layer protocol. The downlink traffic related information may be per IP flow or per port, and such low-level information may not be directly accessible by the BS 111.

As will be described in more detail below, in order to enhance RAN communication, in some aspects, the UE 101 provides traffic related information to the BS 111 as shown by an arrow 106 through RRC signaling, MAC CE, and/or PUCCH. The UE 101 may also transmit the traffic related information or adjustments of the traffic related information through a scheduling request (SR) procedure using a PUSCH allocated using a PDCCH transmission by the BS 111 upon receiving a scheduling request. The BS 111 can then use the received traffic related information to help to enhance data scheduling, configuration, and/or transmission.

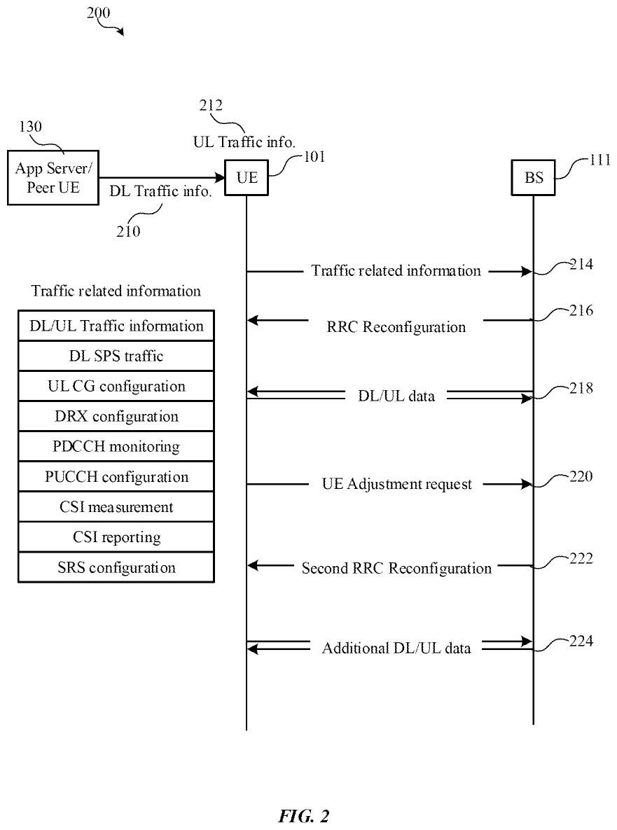

FIG. 2 illustrates a flow diagram 200 showing a method of transmitting traffic related information by the UE 101 to the BS 111 using an RRC message in accordance with some aspects.

As shown by act 210, in some aspects, the UE 101 collects downlink (DL) traffic information from a peer UE or the application server 130. The DL traffic information may include DL traffic flow parameters selected from a list of periodicity, offset, reliability requirement, latency requirement, average packet size, and packet size standard deviation. The DL traffic information of any single parameter or subgroup of the DL traffic flow parameter list is amenable to the disclosure. The DL traffic flow parameter list may also include other parameters that are beneficial to DL data transmission.

As shown by act 212, in some aspects, the UE 101 may also determine, by deriving or receiving uplink (UL) traffic information. The UL traffic information may include UL traffic flow parameters selected from a list of periodicity, offset, reliability requirement, latency requirement, average packet size, packet size standard deviation, importance, flow label, port number, ToS, and IP address. The UL traffic information of any single parameter or subgroup of the UL traffic flow parameter list is amenable to the disclosure. The UL traffic flow parameter list may also include other parameters that are beneficial to UL data transmission.

As shown by act 214, in some aspects, the UE 101 transmits traffic related information to the BS 111. In some aspects, the traffic related information is transmitted using an RRC message. For example, the RRC message may be a UE assistance information message associated with a signaling radio bearer (SRB) using a dedicated control channel (DCCH) logic channel. An example of such an RRC message includes a UE assistance information message UEAssistanceInformation as provided by 3GPP technical specifications.

In some aspects, the traffic related information indicates DL traffic information and UL traffic information of the UE 101. The traffic related information may include the DL traffic information and the UL traffic information as described associated with act 210 and act 212.

In some further aspects, the traffic related information may further include channel configuration preference information of the UE 101.

In one aspect, the traffic related information further includes a DL semi-persistent scheduling (SPS) information. The DL SPS information may indicate periodicity, latency, offset, jitter window size, or amount of spatial layers of a DL SPS. As an example, The DL SPS information may indicate a non-integer periodicity based on application traffic of the UE 101. For example, the non-integer periodicity may be represented by two integers M1/M2 and match a periodicity of the application traffic, such that UE power consumption and HARQ feedback overhead can be reduced.

In another aspect, the traffic related information further includes a UL configured grant (CG) configuration information. The UL CG configuration information may indicate IP address and port, periodicity, latency, offset, or jitter window size of a UL CG.

In another aspect, the traffic related information further includes channel state information (CSI) measurement information and/or CSI reporting information. The CSI measurement and/or the CSI reporting information may indicate a configuration of periodic or semi-persistent CSI measurement and/or reporting. For example, the CSI measurement information may indicate a periodicity of a first integral multiple of the non-integer periodicity of the DL SPS. The CSI reporting information may indicate a periodicity of the same or a second integral multiple of the non-integer periodicity of the DL SPS.

In another aspect, the traffic related information further includes a discontinuous reception (DRX) configuration information. The DRX configuration information may indicate periodicity, offset, or on-duration of a DRX. The DRX configuration information may also match application traffic of the UE 101.

In another aspect, the traffic related information further includes PDCCH monitoring information. The UE 101 can recommend one or multiple search space channel configuration preferences by considering the duration of DL/UL switching. The PDCCH monitoring occasions may also be configured to match SPS and/or CG occasions. The PDCCH monitoring occasions may also be configured to offset CG occasions for a TDD system. In addition, the search spaces may also be configured to include parameters such as duration and monitor symbols within slot monitoringSymbolsWithSlot to induce change in the PDCCH monitoring configuration.

In another aspect, the traffic related information further includes PUCCH configuration information. In another aspect, the traffic related information may further include sounding reference signal (SRS) configuration information.

In some further aspects, the traffic related information is transmitted through a medium access control (MAC) control element (CE). The MAC CE may be transferred using a physical uplink shared channel (PUSCH).

In some further aspects, the traffic related information is transmitted through a physical uplink control channel (PUCCH). A configured PUCCH resource is associated with an uplink control information (UCI) type. The configured PUCCH resource can be for hybrid automatic repeat request acknowledge (HARQ-ACK), scheduling request (SR), or channel state information (CSI) or traffic related information (TRI). In one aspect, more than one UCI types are used for respectively transmitting various traffic related information. For example, a first UCI can be used to transmit traffic information, a second UCI can be used to transmit DRX channel configuration preference, a third UCI can be used to transmit PDCCH monitoring preference, and a fourth UCI can be used to transmit SPS channel configuration preference, etc. The PUCCH can be configured periodic or semi-persistent (P/SP), and thus the UE 101 can report the traffic related information periodically or in a semi-persistent fashion. In some aspects, PUCCH resources or PUCCH resource sets as for dynamic HARQ-ACK feedback can also be configured for transmitting the traffic related information. The UE 101 can be triggered to send the traffic related information over PUCCH in response to a request from the BS 111 through a downlink control information (DCI) message.

In some further aspects, the UE 101 can also request an uplink resource for transmitting traffic related information using a scheduling request (SR) procedure. During the SR procedure, the UE 101 transmits a scheduling request to the BS 111 using UCI PUCCH configured for a specific logic channel. Upon receiving the scheduling request, the BS 111 allocates uplink resources on PUSCH using a DCI PDCCH transmission. Then the UE 101 transmits the traffic related information using the allocated PUSCH through multiplexing.

As shown by act 216, the BS 111 uses the received traffic related information to schedule data transmission and configure the UE 101 according to the traffic related information with DL channel configuration and UL channel configuration respectively related to transmitting DL data and UL data. In some aspects, the UE 101 receives a RRC reconfiguration message from the BS 111. The RRC reconfiguration message configures the UE 101 according to the traffic related information.

As shown by act 218, DL and UL data transmission is performed between the UE 101 and the BS 111 based on the scheduling and configuring of act 216 according to the traffic related information collected, determined, and transmitted as described associated with act 210, act 212, and act 214.

In some aspects, the BS 111 can use the received DL traffic information and/or the received channel configuration information to schedule, configure, and transmit DL data. For example, the DL data may be scheduled, configured, and transmitted to the UE 101 according to the DL traffic information such as periodicity, offset, reliability requirement, latency requirement, average packet size, or packet size standard deviation. In another aspect, the BS 111 can use the received DL SPS information to configure periodicity, latency, offset, jitter window size, or amount of spatial layers of the DL SPS. In another aspect, the BS 111 can use the received DRX traffic information to configure periodicity, offset, or on-duration of the DRX.

In some further aspects, the BS 111 can use the received UL traffic information and/or the received channel configuration information to schedule UL data for the UE 101. For example, the UL data may be scheduled and then transmitted from the UE 101 according to the UL traffic information such as periodicity, offset, reliability requirement, latency requirement, average packet size, packet size standard deviation, importance, flow label, port number, ToS, or IP address. In another aspect, the BS 111 can use the received UL CG configuration information to configure the UL CG with the indicated IP address and port, periodicity, latency, offset, or jitter window size. In another aspect, CSI measurement information and/or CSI reporting information are used to configure periodic or semi-persistent CSI measurement and/or reporting. For example, a CSI measurement may be performed with a periodicity of a first integral multiple of the non-integer periodicity of the DL SPS according to the CSI measurement information. A CSI reporting may be performed with a periodicity of the same or a second integral multiple of the non-integer periodicity of the DL SPS according to the CSI reporting information. In another aspect, the BS 111 may use the received DRX configuration information to configure the DRX with the indicated periodicity, offset, or on-duration. The DRX may be transmitted matching the application traffic of the UE 101.

As an example, by transmitting the traffic related information to the BS 111, the UE 101 can provide a map of traffic flows to the BS 111 containing higher layer information such as information of group of pictures. For example, the traffic related information may indicate a labeling scheme such as a flow label for I-frame or a flow label for P-frame as in video codec, so the BS 111 can configure/use its resource better. In another example, the traffic related information can be used to group IP flows. If video and audio are carried over different IP flows, the UE 101 can also indicate two or more IP flows should be treated together so the timely deliveries of all the packets from those flows can be achieved. In another example, the traffic related information can be used to indicate the remaining latency budget for a packet at a flow, for example, by referring to a sequence number at a given layer.

As shown by act 220, in some additional aspects, the UE 101 can provide an adjustment request after receiving the DL/UL data transmission. The adjustment request may include requesting adjustment of channel configurations of the traffic related information such as CG, DRX, CSI reporting, or SPS. The channel configurations can be recollected and updated by the UE 101 and transmitted to the BS 111 to provide adjustment information. In some aspects, the adjustment request is transmitted to the BS 111 by a RRC message, a MAC CE, or a PUCCH. In one aspect, the channel configuration adjustment is configured in a way similar to the traffic related information as described above associated with act 214. In an alternative aspect, the traffic related information adjustment indicates changes for traffic information or channel configuration preferences. For example, the adjustment request may include requesting SPS or CG offset adjustment. The SPS or CG offset adjustment may have an offset matching an offset of the application traffic of the UE 101.

As shown by act 222, in one aspect, the BS 111 transmits a second RRC reconfiguration message and uses the received adjustment request to update channel configuration or schedule for the UE 101. The second RRC reconfiguration may provide parameters for the updated channel configuration including changes from the previous channel configurations including CG, DRX, CSI reporting, or SPS.

As shown by act 224, additional DL/UL data transmission is performed between the UE 101 and the BS 111 based on the updated configuration and schedule information of act 222 according to the adjustment request transmitted as described associated with act 220 and act 222.

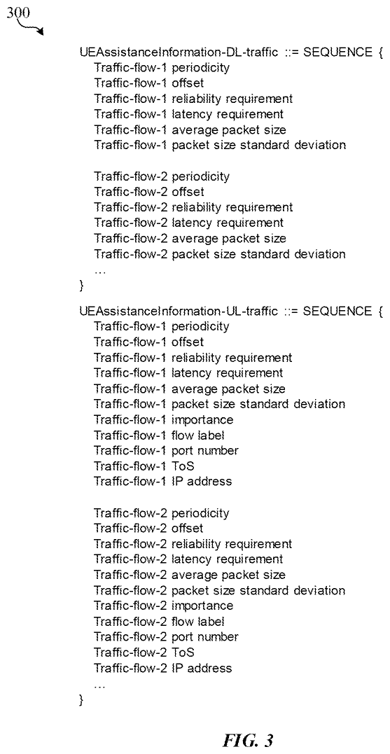

FIG. 3 illustrates a diagram 300 showing an example definition of traffic information included in the RRC message of FIG. 2 in accordance with some aspects. As described above, though a UE assistance information message UEAssistanceInformation is used in FIG. 3 as an example for illustration purposes, other RRC messages, MAC CE, or PUCCH can be used to transmit the traffic information.

As shown in FIG. 3, the traffic related information may include DL traffic information for one or multiple DL traffic flows with DL traffic flow parameters. The DL traffic flow parameters can be selected from a list of periodicity, offset, reliability requirement, latency requirement, average packet size, and packet size standard deviation. The DL traffic information of any single parameter or subgroup of the DL traffic flow parameter list is amenable to the disclosure. The DL traffic flow parameter list may also include other parameters that are beneficial to DL data transmission.

The traffic related information may also include UL traffic information for one or multiple UL traffic flows with UL traffic flow parameters. The UL traffic flow parameters can be selected from a list of periodicity, offset, reliability requirement, latency requirement, average packet size, packet size standard deviation, importance, flow label, port number, ToS, and IP address. The UL traffic information of any single parameter or subgroup of the UL traffic flow parameter list is amenable to the disclosure. The UL traffic flow parameter list may also include other parameters that are beneficial to UL data transmission.

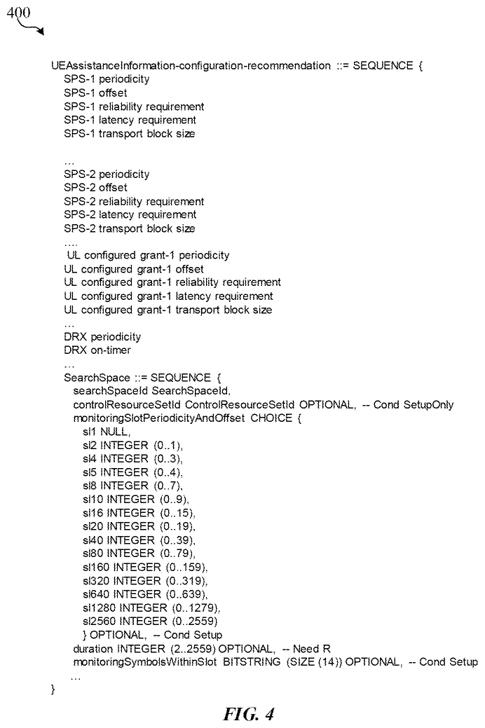

FIG. 4 illustrates a diagram showing an example definition of traffic information included in the RRC message of FIG. 2 in accordance with some additional aspects. Though a UE assistance information message UEAssistanceInformation is used in FIG. 4 as an example for illustration purposes, other RRC messages, MAC CE, or PUCCH can be used to transmit the traffic information.

As shown in FIG. 4, the traffic related information may further include channel configuration preference information. For example, the traffic related information further includes channel configuration preference information for one or multiple DL SPSs and/or UL CGs configuration information. The channel configuration preference information of the DL SPSs may respectively include a list of periodicity, offset, reliability requirement, latency requirement, and transport block size. The channel configuration preference information of the UL CGs may respectively include a list of IP address and port, periodicity, latency, offset, and jitter window size. Any single parameter or subgroup of the list is amenable to the disclosure. The channel configuration preference information may also include other parameters that are beneficial to the DL SPS or the UL CG transmission. The traffic related information may also include other channel configuration preference information such as DRX configuration information including parameters such as periodicity, offset, or on-duration and PDCCH search space information including parameters such as monitoring slot periodicity and offset, duration, and monitoring symbols within slot monitoringSymbolsWithSlot to induce change in the PDCCH monitoring configuration.

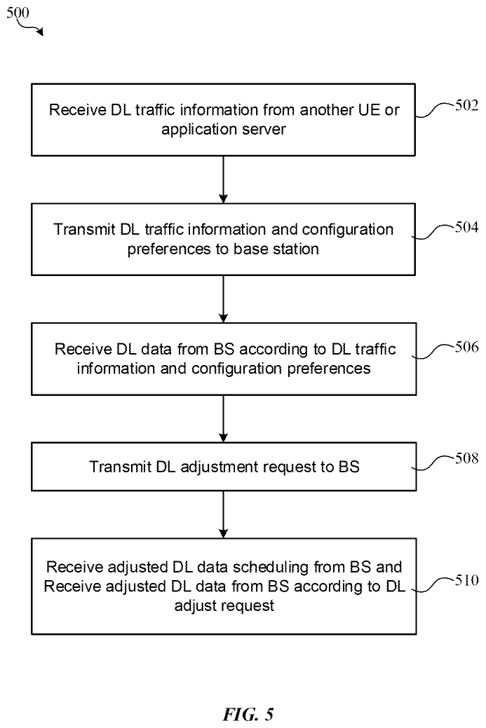

FIG. 5 illustrates a flow diagram 500 showing a method of traffic information indication for downlink data transmission of a UE such as an extended reality (XR) device in accordance with some aspects.

As shown by act 502, DL traffic information is received by the UE from another UE device or an application server. In some aspects, DL channel configuration preference information is also received or otherwise determined by the UE.

As shown by act 504, the DL traffic information and the channel configuration preference information (if applicable) are transmitted from the UE to a BS. The BS may then schedule and configure a DL data transmission based on the received DL traffic information and channel configuration preference information. In one aspect, the DL data transmission is scheduled and configured by a RRC reconfiguration message.

As shown by act 506, the DL data is received from the BS according to the DL traffic information and channel configuration preference information.

As shown by act 508, in some aspects, a DL adjustment request is transmitted to the BS when there is a change or adjustment need of DL channel configuration preference. In one aspect, DL channel configuration preference can be recollected and updated by the UE and transmitted to the BS to provide adjustment information. In an alternative aspect, the DL adjustment request indicates changes for DL channel configuration preferences in comparison to previous DL channel configuration preferences. For example, the DL adjustment request may include requesting an adjustment amount of SPS offset. The SPS offset adjustment may result in an offset matching an offset of the application traffic of the UE to save power consumption and signaling overhead.

As shown by act 510, In one aspect, the updated DL channel configuration is received from the BS by a second RRC reconfiguration message. DL data is then received from the BS according to the updated DL channel configuration.

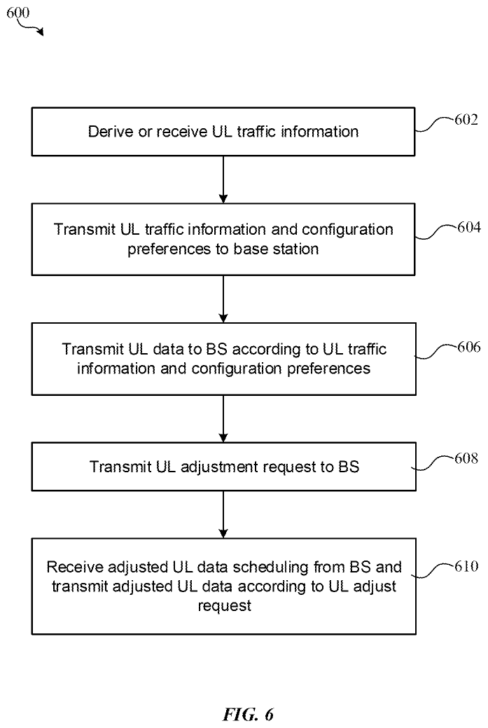

FIG. 6 illustrates a flow diagram 600 showing a method of traffic information indication for uplink data transmission of a UE such as an extended reality (XR) device in accordance with some aspects. It is appreciated that the method shown and described associated with FIG. 5 about downlink operations can be incorporated with the method shown and described associated with FIG. 6 about uplink operations and performed by the same UE such as the same XR device concurrently or timely staggered in an applicable manner.

As shown by act 602, UL traffic information is derived or otherwise determined by the UE from another UE device or an application server. In some aspects, UL channel configuration preference information is also received or derived by the UE.

As shown by act 604, the UL traffic information and channel configuration preference information are transmitted from the UE to a BS. The BS may then schedule an UL data transmission based on the received UL traffic information and channel configuration preference information. In one aspect, the UL data transmission is scheduled and configured by a RRC reconfiguration message.

As shown by act 606, the UL data is transmitted to the BS according to the UL traffic information and/or channel configuration preference information.

As shown by act 608, in some aspects, a UL adjustment request is transmitted to the BS when there is a change or adjustment need of UL channel configuration preference. In one aspect, UL channel configuration preference can be recollected and updated by the UE and retransmitted to the BS to provide adjustment information. In an alternative aspect, the UL adjustment request indicates changes for UL channel configuration preferences. For example, the UL adjustment request may include requesting an adjustment amount of CG offset. The CG offset adjustment may result in an offset matching an offset of the application traffic of the UE to save power consumption and signaling overhead.

As shown by act 610, in some aspects, an updated UL channel configuration is received from the BS according to the UL adjustment request. In one aspect, the updated UL channel configuration is scheduled and configured by a second RRC reconfiguration message. An adjusted UL data is then transmitted to the BS according to the UL adjustment request.

Referring back to FIG. 1, in some aspects, all or parts of the BS 111 can be implemented as one or more software entities running on server computers as part of a virtual network, which can be referred to as a centralized RAN (CRAN) and/or a virtual baseband unit pool (vBBUP). In these embodiments, the CRAN or vBBUP can implement a RAN function split, such as a Packet Data Convergence Protocol (PDCP) split wherein Radio Resource Control (RRC) and PDCP layers are operated by the CRAN/vBBUP and other L2 protocol entities are operated by individual BS 111; a Media Access Control (MAC)/Physical (PHY) layer split wherein RRC, PDCP, RLC, and MAC layers are operated by the CRAN/vBBUP and the PHY layer is operated by individual BS 111; or a “lower PHY” split wherein RRC, PDCP, RLC, MAC layers and upper portions of the PHY layer are operated by the CRAN/vBBUP and lower portions of the PHY layer are operated by individual BS 111. This virtualized framework allows the freed-up processor cores of the BS 111 to perform other virtualized applications.

In some implementations, an individual BS 111 can represent individual gNB-Distributed Units (DUs) that are connected to a gNB-Control Unit (CU) via individual F1 interfaces. In these implementations, the gNB-DUs can include one or more remote radio heads or RF front end modules (RFEMs), and the gNB-CU can be operated by a server that is located in the RAN 110 (not shown) or by a server pool in a similar manner as the CRAN/vBBUP. In some instances, the gNB-DUs, gNB-CUs, or other functions of the BS 111 may be co-located, while in other instances are not co-located and/or operated by different entities.

In some aspects, one of the BS 111 can terminate the air interface protocol and can be the first point of contact for the UEs 101. In some aspects, one of the BS 111 can fulfill various logical functions for the RAN 110, including but not limited to radio network controller (RNC) functions such as radio bearer management, uplink and downlink dynamic radio resource management and data packet scheduling, and mobility management.

In some embodiments, the UEs 101 can be configured to communicate using Orthogonal Frequency-Division Multiplexing (OFDM) communication signals with each other or with any of the BS 111 over a multicarrier communication channel in accordance with various communication techniques, such as, but not limited to, an OFDMA communication technique (e.g., for downlink communications) or a Single Carrier Frequency-Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some aspects, a downlink resource grid can be used for downlink transmissions from any of the BS 111 to the UEs 101, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this can represent the smallest quantity of resources that currently can be allocated. There are several different physical downlink channels that are conveyed using such resource blocks.

The physical downlink shared channel (PDSCH) carries user data and higher-layer signaling from the RAN 110 to the UEs 101. The physical downlink controlled channel (PDCCH) carries information about the transport format and resource allocations related to the PDSCH channel, among other things. It can also inform the UEs 101 about the transport format, resource allocation, and Hybrid Automatic Repeat Request (HARQ) information related to the uplink shared channel. Typically, downlink scheduling (assigning control and shared channel resource blocks to the UE 101b within a cell) can be performed at any of the BS 111 based on channel quality information fed back from any of the UEs 101. The downlink resource assignment information can be sent on the PDCCH used for (e.g., assigned to) each of the UEs 101.

The PDCCH uses control channel elements (CCEs) to convey the control information. Before being mapped to resource elements, the PDCCH complex-valued symbols can first be organized into quadruplets, which can then be permuted using a sub-block interleaver for rate matching. Each PDCCH can be transmitted using one or more of these CCEs, where each CCE can correspond to nine sets of four physical resource elements known as REGs. Four Quadrature Phase Shift Keying (QPSK) symbols can be mapped to each REG. The PDCCH can be transmitted using one or more CCEs, depending on the size of the DCI and the channel condition. There can be four or more different PDCCH formats defined in LTE with different numbers of CCEs (e.g., aggregation level, L=1, 2, 4, 8, 16).

In aspects where the wireless system 100 is a 5G or NR system, the interface 112 can be an Xn interface 112. The Xn interface is defined between two or more BS 111 (e.g., two or more gNBs and the like) that connect to 5GC 120, between a BS 111 (e.g., a gNB) connecting to 5GC 120 and an eNB, and/or between two eNBs connecting to 5GC 120. In some implementations, the Xn interface can include an Xn user plane (Xn-U) interface and an Xn control plane (Xn-C) interface. The Xn-U can provide non-guaranteed delivery of user plane PDUs and support/provide data forwarding and flow control functionality. The Xn-C can provide management and error handling functionality, functionality to manage the Xn-C interface; mobility support for UE 101 in a connected mode (e.g., CM-CONNECTED) including functionality to manage the UE mobility for connected mode between one or more BS 111. The mobility support can include context transfer from an old (source) serving BS 111 to new (target) serving BS 111; and control of user plane tunnels between old (source) serving BS 111 to new (target) serving BS 111. A protocol stack of the Xn-U can include a transport network layer built on Internet Protocol (IP) transport layer, and a GPRS Tunnelling Protocol for User Plane (GTP-U) layer on top of a User Datagram Protocol (UDP) and/or IP layer(s) to carry user plane PDUs. The Xn-C protocol stack can include an application layer signaling protocol (referred to as Xn Application Protocol (Xn-AP)) and a transport network layer that is built on Stream Control Transmission Protocol (SCTP). The SCTP can be on top of an IP layer, and can provide the guaranteed delivery of application layer messages. In the transport IP layer, point-to-point transmission is used to deliver the signaling PDUs. In other implementations, the Xn-U protocol stack and/or the Xn-C protocol stack can be same or similar to the user plane and/or control plane protocol stack(s) shown and described herein.

Core NW elements/components can include one or more of the following functions and network components: an authentication server function (AUSF); an access and mobility management function (AMF); a session management function (SMF); a network exposure function (NEF); a policy control function (PCF); a network repository function (NRF); a unified data management (UDM); an application function (AF); a user plane function (UPF); and a network slice selection function (NSSF).

The UPF, for example, can act as an anchor point for intra-RAT and inter-RAT mobility, an external protocol data unit (PDU) session point of interconnect to data network (DN), and a branching point to support multi-homed PDU session. The UPF can also perform packet routing and forwarding, perform packet inspection, enforce the user plane part of policy rules, lawfully intercept packets (UP collection), perform traffic usage reporting, perform QoS handling for a user plane (e.g., packet filtering, gating, Uplink (UL)/Downlink (DL) rate enforcement), perform Uplink Traffic verification (e.g., Service Data Flow (SDF) to QoS flow mapping), transport level packet marking in the uplink and downlink, and perform downlink packet buffering and downlink data notification triggering. UPF can include an uplink classifier to support routing traffic flows to a data network. A DN can be various network operator services, Internet access, or third-party services, include, or be similar to, an application server. The UPF can interact with the SMF via an N4 reference point between the SMF and the UPF.

The AUSF, for example, can store data for authentication of UE 101 and handle authentication-related functionality. The AUSF can facilitate a common authentication framework for various access types. The AUSF can communicate with the AMF via an N12 reference point between the AMF and the AUSF; and can communicate with the UDM via an N13 reference point between the UDM and the AUSF. Additionally, the AUSF can exhibit an Nausf service-based interface.

The AMF, for example, can be responsible for registration management (e.g., for registering UE 101, etc.), connection management, reachability management, mobility management, and lawful interception of AMF-related events, and access authentication and authorization. The AMF can be a termination point for the N11 reference point between the AMF and the SMF. The AMF can provide transport for SM messages between the UE 101 and the SMF, and act as a transparent proxy for routing SM messages. AMF can also provide transport for SMS messages between UE 101 and a Short Message Service (SMS) Function (SMSF). AMF can act as Security Anchor Function (SEAF), which can include interaction with the AUSF and the UE 101 and/or receipt of an intermediate key that was established as a result of the UE 10 authentication process. Where Universal Subscriber Identity Module (USIM) based authentication is used, the AMF can retrieve the security material from the AUSF. AMF can also include a Single-Connection Mode (SCM) function, which receives a key from the SEA that it uses to derive access-network specific keys. Furthermore, AMF can be a termination point of a RAN Control Plane (CP) interface, which can include or be an N2 reference point between the (R)AN 110 and the AMF; and the AMF can be a termination point of Non Access Stratum (NAS) (N1) signaling, and perform NAS ciphering and integrity protection.

AMF can also support NAS signaling with a UE 101 over a non-3GPP (N3) Inter Working Function (IWF) interface. The N3IWF can be used to provide access to untrusted entities. N3IWF can be a termination point for the N2 interface between the (R)AN 110 and the AMF for the control plane, and can be a termination point for the N3 reference point between the (R)AN 101 and the UPF for the user plane. As such, the AMF can handle N2 signaling from the SMF and the AMF for PDU sessions and QoS, encapsulate/de-encapsulate packets for Internet Protocol (IP) Security (IPSec) and N3 tunneling, mark N3 user-plane packets in the uplink, and enforce QoS corresponding to N3 packet marking taking into account QoS requirements associated with such marking received over N2. N3IWF can also relay uplink and downlink control-plane NAS signaling between the UE 101 and AMF via an N1 reference point between the UE 101 and the AMF, and relay uplink and downlink user-plane packets between the UE 101 and UPF. The N3IWF also provides mechanisms for IPsec tunnel establishment with the UE 101. The AMF can exhibit an Namf service-based interface, and can be a termination point for an N14 reference point between two AMFs and an N17 reference point between the AMF and a 5G Equipment Identity Register (5G-EIR) (not shown in FIG. 1).

The UE 101 can be registered with the AMF in order to receive network services. Registration Management (RM) is used to register or deregister the UE 101 with the network (e.g., AMF), and establish a UE context in the network (e.g., AMF). The UE 101 can operate in an RM-REGISTERED state or an RM-DEREGISTERED state. In the RM-DEREGISTERED state, the UE 101 is not registered with the network, and the UE context in AMF holds no valid location or routing information for the UE 101 so the UE 101 is not reachable by the AMF. In the RM-REGISTERED state, the UE 101 is registered with the network, and the UE context in AMF can hold a valid location or routing information for the UE 101 so the UE 101 is reachable by the AMF. In the RM-REGISTERED state, the UE 101 can perform mobility Registration Update procedures, perform periodic Registration Update procedures triggered by expiration of the periodic update timer (e.g., to notify the network that the UE 101 is still active), and perform a Registration Update procedure to update UE capability information or to re-negotiate protocol parameters with the network, among others.

The AMF can store one or more RM contexts for the UE 101, where each RM context is associated with a specific access to the network. The RM context can be a data structure, database object, etc. that indicates or stores, inter alia, a registration state per access type and the periodic update timer. The AMF can also store a 5GC mobility management (MM) context that can be the same or similar to an enhanced packet system (EPS) MM context. In various embodiments, the AMF can store a Coverage Enhancement (CE) mode B Restriction parameter of the UE 101 in an associated MM context or RM context. The AMF can also derive the value, when needed, from the UE's usage setting parameter already stored in the UE context (and/or MM/RM context).

The components of the CN 120 can be implemented in one physical node or separate physical nodes including components to read and execute instructions from a machine-readable or computer-readable medium (e.g., a non-transitory machine-readable storage medium). In some aspects, NFV can be utilized to virtualize any or all of the above-described network node functions via executable instructions stored in one or more computer-readable storage mediums (described in further detail below). A logical instantiation of the CN 120 can be referred to as a network slice, and a logical instantiation of a portion of the CN 120 can be referred to as a network sub-slice. Network Function Virtualization (NFV) architectures and infrastructures can be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more Evolved Packet Core (EPC) components/functions.

In aspects, where CN 120 is an EPC, the RAN 110 can be connected with the CN 120 via an S1 interface 113. In embodiments, the S1 interface 113 can be split into two parts, an S1 user plane (S1-U) interface 114, which carries traffic data between the BS 111 and the S-GW, and the S1-MME interface 115, which is a signaling interface between the BS 111 and MMEs.

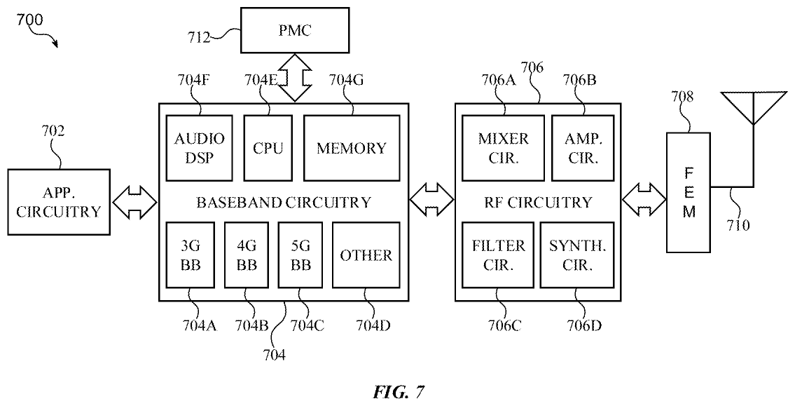

FIG. 7 illustrates a diagram illustrating example components of a device 700 that can be employed in accordance with some aspects. In some implementations, the device 700 can include application circuitry 702, baseband circuitry 704, Radio Frequency (RF) circuitry 706, front-end module (FEM) circuitry 708, one or more antennas 710, and power management circuitry (PMC) 712 coupled together at least as shown. The components of the illustrated device 700 can be included in a UE or a RAN node. In some implementations, the device 700 can include fewer elements (e.g., a RAN node may not utilize application circuitry 702 and instead include a processor/controller to process IP data received from a CN. In some implementations, the device 700 can include additional elements such as, for example, memory/storage, display, camera, sensor (including one or more temperature sensors, such as a single temperature sensor, a plurality of temperature sensors at different locations in device 700, etc.), or input/output (I/O) interface. In other implementations, the components described below can be included in more than one device (e.g., said circuitries can be separately included in more than one device for Cloud-RAN (C-RAN) implementations).

The application circuitry 702 can include one or more application processors. For example, the application circuitry 702 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 700. In some implementations, processors of application circuitry 702 can process IP data packets received from an EPC.

The baseband circuitry 704 can include circuitry such as, but not limited to, one or more single-core or multi-core processors. The baseband circuitry 704 can include one or more baseband processors or control logic to process baseband signals received from a receive signal path of the RF circuitry 706 and to generate baseband signals for a transmit signal path of the RF circuitry 706. Baseband circuitry 704 can interface with the application circuitry 702 for generation and processing of the baseband signals and for controlling operations of the RF circuitry 706. For example, in some implementations, the baseband circuitry 704 can include a third generation (3G) baseband processor 704A, a fourth generation (4G) baseband processor 704B, a fifth generation (5G) baseband processor 704C, or other baseband processor(s) 704D for other existing generations, generations in development or to be developed in the future (e.g., second generation (2G), sixth generation (6G), etc.). The baseband circuitry 704 (e.g., one or more of baseband processors 704A-D) can handle various radio control functions that enable communication with one or more radio networks via the RF circuitry 706. In other implementations, some or all of the functionality of baseband processors 704A-D can be included in modules stored in the memory 704G and executed via a Central Processing Unit (CPU) 704E. The radio control functions can include but are not limited to signal modulation/demodulation, encoding/decoding, radio frequency shifting, etc. In some implementations, modulation/demodulation circuitry of the baseband circuitry 704 can include Fast-Fourier Transform (FFT), precoding, or constellation mapping/demapping functionality. In some implementations, encoding/decoding circuitry of the baseband circuitry 704 can include convolution, tail-biting convolution, turbo, Viterbi, or Low Density Parity Check (LDPC) encoder/decoder functionality. Implementations of modulation/demodulation and encoder/decoder functionality are not limited to these examples and can include other suitable functionality in other implementations.

In some implementations, the baseband circuitry 704 can include one or more audio digital signal processor(s) (DSP) 704F. The audio DSP(s) 704F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 704 and the application circuitry 702 can be implemented together such as, for example, on a system on a chip (SOC).

In some implementations, the baseband circuitry 704 can provide for communication compatible with one or more radio technologies. For example, in some implementations, the baseband circuitry 704 can support communication with an NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 704 is configured to support radio communications of more than one wireless protocol can be referred to as multi-mode baseband circuitry.

RF circuitry 706 can enable communication with wireless networks using modulated electromagnetic radiation through a non-solid medium. In various implementations, the RF circuitry 706 can include switches, filters, amplifiers, etc., to facilitate communication with the wireless network. RF circuitry 706 can include a receive signal path which can include circuitry to down-convert RF signals received from the FEM circuitry 708 and provide baseband signals to the baseband circuitry 704. RF circuitry 706 can also include a transmit signal path which can include circuitry to up-convert baseband signals provided by the baseband circuitry 704 and provide RF output signals to the FEM circuitry 708 for transmission.

In some implementations, the receive signal path of the RF circuitry 706 can include mixer circuitry 706a, amplifier circuitry 706b, and filter circuitry 706c. In some implementations, the transmit signal path of the RF circuitry 706 can include filter circuitry 706c and mixer circuitry 706a. RF circuitry 706 can also include synthesizer circuitry 706d for synthesizing a frequency for use by the mixer circuitry 706a of the receive signal path and the transmit signal path. In some implementations, the mixer circuitry 706a of the receive signal path can be configured to down-convert RF signals received from the FEM circuitry 708 based on the synthesized frequency provided by synthesizer circuitry 706d. The amplifier circuitry 706b can be configured to amplify the down-converted signals, and the filter circuitry 706c can be a low-pass filter (LPF) or band-pass filter (BPF) configured to remove unwanted signals from the down-converted signals to generate output baseband signals. Output baseband signals can be provided to the baseband circuitry 704 for further processing. In some implementations, the output baseband signals can be zero-frequency baseband signals, although this is not a requirement. In some implementations, mixer circuitry 706a of the receive signal path can comprise passive mixers, although the scope of the implementations is not limited in this respect.

In some implementations, the mixer circuitry 706a of the transmit signal path can be configured to up-convert input baseband signals based on the synthesized frequency provided by the synthesizer circuitry 706d to generate RF output signals for the FEM circuitry 708. The baseband signals can be provided by the baseband circuitry 704 and can be filtered by filter circuitry 706c.

In some implementations, the mixer circuitry 706a of the receive signal path and the mixer circuitry 706a of the transmit signal path can include two or more mixers and can be arranged for quadrature downconversion and upconversion, respectively. In some implementations, the mixer circuitry 706a of the receive signal path and the mixer circuitry 706a of the transmit signal path can include two or more mixers and can be arranged for image rejection (e.g., Hartley image rejection). In some implementations, the mixer circuitry 706a of the receive signal path and the mixer circuitry 706a can be arranged for direct downconversion and direct upconversion, respectively. In some implementations, the mixer circuitry 706a of the receive signal path and the mixer circuitry 706a of the transmit signal path can be configured for super-heterodyne operation.

In some implementations, the output baseband signals and the input baseband signals can be analog baseband signals, although the scope of the implementations is not limited in this respect. In some alternate implementations, the output baseband signals and the input baseband signals can be digital baseband signals. In these alternate implementations, the RF circuitry 706 can include analog-to-digital converter (ADC) and digital-to-analog converter (DAC) circuitry, and the baseband circuitry 704 can include a digital baseband interface to communicate with the RF circuitry 706.

In some dual-mode implementations, a separate radio IC circuitry can be provided for processing signals for each spectrum, although the scope of the implementations is not limited in this respect.

In some implementations, the synthesizer circuitry 706d can be a fractional-N synthesizer or a fractional N/N+1 synthesizer, although the scope of the implementations is not limited in this respect as other types of frequency synthesizers can be suitable. For example, synthesizer circuitry 706d can be a delta-sigma synthesizer, a frequency multiplier, or a synthesizer comprising a phase-locked loop with a frequency divider.

The synthesizer circuitry 706d can be configured to synthesize an output frequency for use by the mixer circuitry 706a of the RF circuitry 706 based on a frequency input and a divider control input. In some implementations, the synthesizer circuitry 706d can be a fractional N/N+1 synthesizer.

In some implementations, frequency input can be provided by a voltage-controlled oscillator (VCO), although that is not a requirement. Divider control input can be provided by either the baseband circuitry 704 or the application circuitry 702, depending on the desired output frequency. In some implementations, a divider control input (e.g., N) can be determined from a look-up table based on a channel indicated by the application circuitry 702.

Synthesizer circuitry 706d of the RF circuitry 706 can include a divider, a delay-locked loop (DLL), a multiplexer, and a phase accumulator. In some implementations, the divider can be a dual modulus divider (DMD), and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump, and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 706d can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 706 can include an IQ/polar converter.

FEM circuitry 708 can include a receive signal path which can include circuitry configured to operate on RF signals received from one or more antennas 56, amplify the received signals and provide the amplified versions of the received signals to the RF circuitry 706 for further processing. FEM circuitry 708 can also include a transmit signal path which can include circuitry configured to amplify signals for transmission provided by the RF circuitry 706 for transmission by one or more of the one or more antennas 56.

In various implementations, the amplification through the transmit or receive signal paths can be done solely in the RF circuitry 706, solely in the FEM circuitry 708, or in both the RF circuitry 706 and the FEM circuitry 708.

In some implementations, the FEM circuitry 708 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 706). The transmit signal path of the FEM circuitry 708 can include a power amplifier (PA) to amplify input RF signals (e.g., provided by RF circuitry 706), and one or more filters to generate RF signals for subsequent transmission (e.g., by one or more of the one or more antennas 56).

In some implementations, the PMC 712 can manage power provided to the baseband circuitry 704. In particular, the PMC 712 can control power-source selection, voltage scaling, battery charging, or DC-to-DC conversion. The PMC 712 can often be included when the device 700 is capable of being powered by a battery, for example, when the device is included in a UE. The PMC 712 can increase the power conversion efficiency while providing desirable implementation size and heat dissipation characteristics.

While FIG. 7 shows the PMC 712 coupled only with the baseband circuitry 704. However, in other implementations, the PMC 712 may be additionally or alternatively coupled with, and perform similar power management operations for, other components such as, but not limited to, application circuitry 702, RF circuitry 706, or FEM circuitry 708.

In some implementations, the PMC 712 can control, or otherwise be part of, various power saving mechanisms of the device 700. For example, if the device 700 is in an RRC_Connected state, where it is still connected to the RAN node as it expects to receive traffic shortly, then it can enter a state known as Discontinuous Reception Mode (DRX) after a period of inactivity. During this state, the device 700 can power down for brief intervals of time and thus save power.

If there is no data traffic activity for an extended period of time, then the device 700 can transition off to an RRC_Idle state, where it disconnects from the network and does not perform operations such as channel quality feedback, handover, etc. The device 700 goes into a very low power state and it performs paging where again it periodically wakes up to listen to the network and then powers down again. The device 700 may not receive data in this state; in order to receive data, it can transition back to RRC_Connected state.

An additional power saving mode can allow a device to be unavailable to the network for periods longer than a paging interval (ranging from seconds to a few hours). During this time, the device is totally unreachable to the network and can power down completely. Any data sent during this time incurs a large delay and it is assumed the delay is acceptable.

Processors of the application circuitry 702 and processors of the baseband circuitry 704 can be used to execute elements of one or more instances of a protocol stack. For example, processors of the baseband circuitry 704, alone or in combination, can be used execute Layer 3, Layer 2, or Layer 1 functionality, while processors of the baseband circuitry 704 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control (RRC) layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

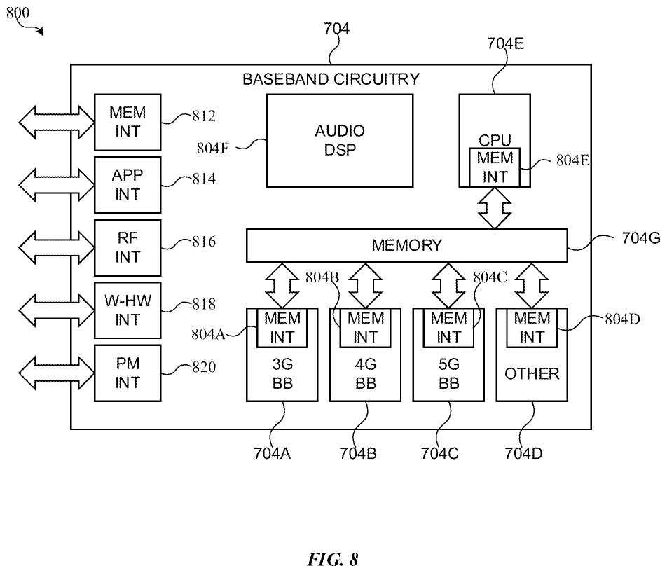

FIG. 8 illustrates a diagram illustrating example interfaces of baseband circuitry that can be employed in accordance with some aspects. As discussed above, the baseband circuitry 704 of FIG. 7 can comprise processors 704A-704E and a memory 704G utilized by said processors. Each of the processors 704A-704E can include a memory interface, 804A-804E, respectively, to send/receive data to/from the memory 704G.

The baseband circuitry 704 can further include one or more interfaces to communicatively couple to other circuitries/devices, such as a memory interface 812 (e.g., an interface to send/receive data to/from memory external to the baseband circuitry 704), an application circuitry interface 814 (e.g., an interface to send/receive data to/from the application circuitry 702 of FIG. 7), an RF circuitry interface 816 (e.g., an interface to send/receive data to/from RF circuitry 706 of FIG. 7), a wireless hardware connectivity interface 818, and a power management interface 620 (e.g., an interface to send/receive power or control signals to/from the PMC 712).

While the methods described within this disclosure are illustrated in and described herein as a series of acts or events, it will be appreciated that the illustrated ordering of such acts or events are not to be interpreted in a limiting sense. For example, some acts can occur in different orders and/or concurrently with other acts or events apart from those illustrated and/or described herein. In addition, not all illustrated acts can be required to implement one or more aspects or embodiments of the description herein. Further, one or more of the acts depicted herein can be carried out in one or more separate acts and/or phases. Reference can be made to the figures described above for ease of description. However, the methods are not limited to any particular embodiment, aspect or example provided within this disclosure and can be applied to any of the systems/devices/components disclosed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units.

### Additional Examples

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to aspects and examples described.

Example 1 is a baseband processor for a user equipment (UE) configured to perform operations comprising determining uplink (UL) traffic information as part of a traffic related information, transmitting the traffic related information to a base station (BS), receiving a radio resource control (RRC) reconfiguration message from the BS, wherein the RRC reconfiguration message configures the UE according to the traffic related information with UL radio parameters related to transmitting UL data, and transmitting the UL data to the BS according to the traffic related information.

Example 2 comprises the subject matter of any variation of any of example(s) 1, wherein the traffic related information is transmitted to the BS by a radio resource control (RRC) message.

Example 3 comprises the subject matter of any variation of any of example(s) 2, wherein the RRC message is a UE assistance information message UEAssistanceInformation as provided by 3GPP technical specifications.

Example 4 comprises the subject matter of any variation of any of example(s) 1, wherein the traffic related information is transmitted to the BS by a medium access control (MAC) control element (CE).

Example 5 comprises the subject matter of any variation of any of example(s) 1, wherein the traffic related information is transmitted to the BS by a physical uplink control channel (PUCCH).

Example 6 comprises the subject matter of any variation of any of example(s) 1-5, wherein the UL traffic information includes one or more of periodicity, offset, reliability requirement, latency requirement, average packet size, packet size standard deviation, importance, flow label, port number, ToS, or IP address.

Example 7 is a baseband processor for a user equipment (UE) configured to perform operations comprising receiving downlink (DL) traffic information from a peer UE or an application server as part of a traffic related information, transmitting the traffic related information to a base station (BS), receiving a radio resource control (RRC) reconfiguration message from the BS, wherein the RRC reconfiguration message configures the UE according to the traffic related information with DL radio parameters related to transmitting DL data, and receiving the DL data from the BS according to the DL traffic information of the traffic related information.

Example 8 comprises the subject matter of any variation of any of example(s) 7, wherein the DL traffic information includes one of more of periodicity, offset, reliability requirement, latency requirement, average packet size, or packet size standard deviation.

Example 9 comprises the subject matter of any variation of any of example(s) 7-8, wherein the traffic related information further comprises a DL semi-persistent scheduling (SPS) information indicating periodicity, latency, offset, jitter window size, or amount of spatial layers of a DL SPS.

Example 10 comprises the subject matter of any variation of any of example(s) 9, wherein the DL SPS information indicates a non-integer periodicity based on application traffic of the UE.

Example 11 comprises the subject matter of any variation of any of example(s) 7-10, wherein the traffic related information further comprises a UL configured grant (CG) configuration information indicating IP address and port, periodicity, latency, offset, or jitter window size of a UL CG.

Example 12 comprises the subject matter of any variation of any of example(s) 7-10, wherein the traffic related information further comprises a channel state information (CSI) measurement information and a CSI reporting information.

Example 13 comprises the subject matter of any variation of any of example(s) 12, wherein the CSI measurement information indicates a periodicity of a first integral multiple of the non-integer periodicity of the DL SPS; and wherein the CSI reporting information indicates a periodicity of the same or a second integral multiple of the non-integer periodicity of the DL SPS.

Example 14 comprises the subject matter of any variation of any of example(s) 7-13, wherein the traffic related information further comprises discontinuous reception (DRX) configuration information indicating periodicity, offset, or on-duration of a DRX.

Example 15 comprises the subject matter of any variation of any of example(s) 14, wherein the DRX configuration information is based on an application traffic of the UE.

Example 16 comprises the subject matter of any variation of any of example(s) 7-15, wherein the traffic related information further comprises PDCCH monitoring information.

Example 17 comprises the subject matter of any variation of any of example(s) 7-16, wherein the traffic related information further comprises PUCCH configuration information.

Example 18 is a baseband processor for a user equipment (UE) configured to perform operations comprising receiving a radio resource control (RRC) reconfiguration message from a base station (BS) wherein the RRC reconfiguration message configures UE with a channel configuration for data traffic, transmitting an adjustment request to the BS, the adjustment request including requesting adjustment of channel configuration, receiving a second RRC reconfiguration message from the BS, wherein the second RRC reconfiguration message configures the UE with an updated channel configuration based on the adjustment request, and transmitting and receiving data with the BS according to the second channel configuration.

Example 19 comprises the subject matter of any variation of any of example(s) 18, wherein the channel configuration comprises semi-persistent scheduling (SPS) configuration and/or configured grant (CG) configuration.

Example 20 comprises the subject matter of any variation of any of example(s) 19, wherein the adjustment request including requesting adjustment of semi-persistent scheduling (SPS) offset or configured grant (CG) offset; and wherein the SPS offset or the CG offset adjustment request matches an offset of the SPS or CG to that of an application traffic of the UE.

Example 21 is a baseband processor for a user equipment (UE) configured to perform operations comprising transmitting a radio resource control (RRC) message to a base station (BS), the RRC message including traffic related information indicating downlink (DL) traffic information and uplink (UL) traffic information of the UE, receiving a radio resource control (RRC) reconfiguration message from the BS, wherein the RRC reconfiguration message configures the UE according to the traffic related information, receiving DL data from the BS according to the traffic related information, transmitting UL data to the BS according to the traffic related information.

Example 22 comprises the subject matter of any variation of any of example(s) 21, wherein the RRC message is a UE assistance information message UEAssistanceInformation as provided by 3GPP technical specifications.

Example 23 comprises the subject matter of any variation of any of example(s) 21, wherein the RRC message further includes a DL semi-persistent scheduling (SPS) information indicating periodicity, latency, offset, jitter window size, or amount of spatial layers of a DL SPS, a UL configured grant (CG) configuration information indicating IP address and port, periodicity, latency, offset, or jitter window size of a UL CG, a channel state information (CSI) measurement information, a CSI reporting information, or a discontinuous reception (DRX) configuration information.

Example 24 comprises the subject matter of any variation of any of example(s) 21, wherein the DL traffic information of the UE includes periodicity, offset, reliability requirement, latency requirement, average packet size, or packet size standard deviation.

Example 25 comprises the subject matter of any variation of any of example(s) 24, wherein the UL traffic information of the UE includes periodicity, offset, reliability requirement, latency requirement, average packet size, packet size standard deviation, importance, flow label, port number, ToS, or IP address.

Example 26 comprises the subject matter of any variation of any of example(s) 25, further configured to perform operations comprising receiving the DL traffic information from a peer UE or an application server and determining the UL traffic information by the UE.

Example 27 is a baseband processor for a user equipment (UE) configured to perform operations comprising receiving downlink (DL) traffic information for the UE from a peer UE or an application server, determining uplink (UL) traffic information for the UE, transmitting a traffic related information to a base station (BS), the traffic related information including the DL traffic information and the UL traffic information, receiving a radio resource control (RRC) reconfiguration message from the BS, wherein the RRC reconfiguration message configures the UE according to the traffic related information, receiving DL data from the BS according to the DL traffic information, and transmitting UL data to the BS according to the UL traffic information.

Example 28 comprises the subject matter of any variation of any of example(s) 27, wherein the traffic related information is transmitted to the BS by a radio resource control (RRC) message, a medium access control (MAC) control element (CE), or a physical uplink control channel (PUCCH).

Example 29 comprises the subject matter of any variation of any of example(s) 28, wherein the RRC message is a UE assistance information message UEAssistanceInformation as provided by 3GPP technical specifications.

Example 30 comprises the subject matter of any variation of any of example(s) 27, wherein the traffic related information further includes a DL semi-persistent scheduling (SPS) information indicating periodicity, latency, offset, jitter window size, or amount of spatial layers of a DL SPS, a UL configured grant (CG) configuration information indicating IP address and port, periodicity, latency, offset, or jitter window size of a UL CG, a channel state information (CSI) measurement information, a CSI reporting information; or a discontinuous reception (DRX) configuration information.

Example 31 comprises the subject matter of any variation of any of example(s) 27, wherein the DL traffic information includes periodicity, offset, reliability requirement, latency requirement, average packet size, or packet size standard deviation.

Example 32 comprises the subject matter of any variation of any of example(s) 27, wherein the UL traffic information includes periodicity, offset, reliability requirement, latency requirement, average packet size, packet size standard deviation, importance, flow label, port number, ToS, or IP address

Example 33 comprises the subject matter of any variation of any of example(s) 28, wherein the PUCCH is configured periodic or semi-persistent.

Example 34 comprises the subject matter of any variation of any of example(s) 28, wherein the UE is triggered to transmit the DL traffic information and the UL traffic information over the PUCCH in response to a request from the BS through a downlink control information (DCI) message.

Example 35 is a baseband processor for a base station (BS) configured to perform operations comprising receiving traffic related information from a user equipment (UE), the traffic related information indicating downlink (DL) traffic information, uplink (UL) traffic information, and configuration preference information, transmitting a radio resource control (RRC) reconfiguration message to the UE, wherein the RRC reconfiguration message configures the UE according to the traffic related information, scheduling, configuring, and transmitting DL data to the UE according to the DL traffic information and the configuration preference information, and scheduling and receiving UL data from the UE according to the UL traffic information and the configuration preference information.

Example 36 is a method to perform traffic information indication for data transmission of an extended reality (XR) device comprising receiving downlink (DL) traffic information from another device or an application server, determining uplink (UL) traffic information, transmitting traffic related information to a base station (BS), the traffic related information including the DL traffic information and the UL traffic information, and receiving a radio resource control (RRC) reconfiguration message from the BS, wherein the RRC reconfiguration message configures the UE according to the traffic related information, receiving DL data from the BS according to the traffic related information, and transmitting UL data to the BS according to the traffic related information

Example 37 comprises the subject matter of any variation of any of example(s) 36, wherein the traffic related information further includes a DL semi-persistent scheduling (SPS) information indicating periodicity, latency, offset, jitter window size, or amount of spatial layers of a DL SPS, a UL configured grant (CG) configuration information indicating IP address and port, periodicity, latency, offset, or jitter window size of a UL CG, a channel state information (CSI) measurement information, a CSI reporting information; or a discontinuous reception (DRX) configuration information.

Example 38 comprises the subject matter of any variation of any of example(s) 36, wherein the traffic related information is transmitted to the BS by a radio resource control (RRC) message UEAssistanceInformation as provided by 3GPP technical specifications.

Example 39 comprises the subject matter of any variation of any of example(s) 36, wherein the traffic related information is transmitted to the BS by a medium access control (MAC) control element (CE).

Example 40 comprises the subject matter of any variation of any of example(s) 36, wherein the traffic related information is transmitted to the BS by a physical uplink control channel (PUCCH).

Example 41 comprises the subject matter of any variation of any of example(s) 36, wherein the traffic related information is transmitted to the BS by a physical uplink shared channel (PUSCH) allocated by a scheduling request procedure.

1. A baseband processor of a user equipment (UE), the baseband processor configured to perform operations comprising:
determining uplink (UL) traffic information as part of a traffic related information;
transmitting the traffic related information to a base station (BS);
receiving a radio resource control (RRC) reconfiguration message from the BS, wherein the RRC reconfiguration message configures the UE according to the traffic related information with UL radio parameters related to transmitting UL data; and
transmitting the UL data to the BS according to the traffic related information.

2. The baseband processor of claim 1, wherein the traffic related information is transmitted to the BS by a radio resource control (RRC) message.

3. The baseband processor of claim 2, wherein the RRC message is a UE assistance information message UEAssistanceInformation as provided by 3GPP technical specifications.

4. The baseband processor of claim 1, wherein the traffic related information is transmitted to the BS by a medium access control (MAC) control element (CE).

5. The baseband processor of claim 1, wherein the traffic related information is transmitted to the BS by a physical uplink control channel (PUCCH).

6. The baseband processor of claim 1, wherein the UL traffic information includes one or more of periodicity, offset, reliability requirement, latency requirement, average packet size, packet size standard deviation, importance, flow label, port number, ToS, or IP address.

7. A baseband processor of a user equipment (UE), the baseband processor configured to perform operations comprising:
receiving downlink (DL) traffic information from a peer UE or an application server as part of a traffic related information;
transmitting the traffic related information to a base station (BS);
receiving a radio resource control (RRC) reconfiguration message from the BS, wherein the RRC reconfiguration message configures the UE according to the traffic related information with DL radio parameters related to transmitting DL data; and
receiving the DL data from the BS according to the DL traffic information of the traffic related information.

8. The baseband processor of claim 7, wherein the DL traffic information includes one of more of periodicity, offset, reliability requirement, latency requirement, average packet size, or packet size standard deviation.

9. The baseband processor of claim 8, wherein the traffic related information further comprises a DL semi-persistent scheduling (SPS) information indicating periodicity, latency, offset, jitter window size, or amount of spatial layers of a DL SPS.

10. The baseband processor of claim 9, wherein the DL SPS information indicates a non-integer periodicity based on application traffic of the UE.

11. The baseband processor of claim 10, wherein the traffic related information further comprises a UL configured grant (CG) configuration information indicating IP address and port, periodicity, latency, offset, or jitter window size of a UL CG.

12. The baseband processor of claim 10, wherein the traffic related information further comprises a channel state information (CSI) measurement information and a CSI reporting information.

13. The baseband processor of claim 12,
wherein the CSI measurement information indicates a periodicity of a first integral multiple of the non-integer periodicity of the DL SPS; and
wherein the CSI reporting information indicates a periodicity of the same or a second integral multiple of the non-integer periodicity of the DL SPS.

14. The baseband processor of claim 7, wherein the traffic related information further comprises discontinuous reception (DRX) configuration information indicating periodicity, offset, or on-duration of a DRX.

15. The baseband processor of claim 14, wherein the DRX configuration information is based on an application traffic of the UE.

16. The baseband processor of claim 7, wherein the traffic related information further comprises PDCCH monitoring information.

17. The baseband processor of claim 7, wherein the traffic related information further comprises PUCCH configuration information.

18. A baseband processor of a user equipment (UE), the baseband processor configured to perform operations comprising:
receiving a radio resource control (RRC) reconfiguration message from a base station (BS), wherein the RRC reconfiguration message configures UE with a channel configuration for data traffic;
transmitting an adjustment request to the BS, the adjustment request including requesting adjustment of channel configuration;
receiving a second RRC reconfiguration message from the BS, wherein the second RRC reconfiguration message configures the UE with an updated channel configuration based on the adjustment request; and
transmitting and receiving data with the BS according to the updated channel configuration.

19. The baseband processor of claim 18, wherein the channel configuration comprises semi-persistent scheduling (SPS) configuration and/or configured grant (CG) configuration.

20. The baseband processor of claim 19,
wherein the adjustment request including requesting adjustment of semi-persistent scheduling (SPS) offset or configured grant (CG) offset; and
wherein the SPS offset or the CG offset adjustment request matches an offset of the SPS or CG to that of an application traffic of the UE.

21-41. (canceled)
